(19) United States
(12) Patent Application Publication
(10) Pub. No.: US 2008/0157715 A1
(43) Pub. Date: Jul. 3, 2008

(54) Plug-type charger for small electrical device

(75) Inventors: Volker Rosenboom, Friesoythe (DE); Wolfgang Richard Mastnak, Aichach (DE)

Correspondence Address: K.F. ROSS P.C., 5683 RIVERDALE AVENUE, SUITE 203 BOX 900, BRONX, NY, 10471-0900, US

(73) Assignee: EGATE-INTERNATIONAL GmbH

(21) Appl. No.: 11/650,847

(22) Filed: Jan. 8, 2007

(30) Foreign Application Priority Data
Jan. 7, 2006 (DE) 2020026000382.7
Jul. 11, 2006 (DE) 202006010690

(51) Int. Cl. H02J 7/02

(52) U.S. Cl. 320/108

(57) ABSTRACT

An electrical charger equipped with a plug (7) for cableless insertion into a wall receptacle, with a power supply unit and a fixture for holding an electrical low-voltage appliance that is to be charged and has a storage unit for electrical energy, characterized in that the charger is equipped with at least one adapter (4a) for a power socket of the low-voltage appliance and/or with a mount containing a primary winding for the induction of a secondary winding in the low-voltage appliance that can be accommodated on the mount.

The invention relates to an electrical charger equipped with a plug for cableless insertion into a wall receptacle, with a power supply unit and a fixture for holding an electrical low-voltage appliance that is to be charged and has a storage unit for electrical energy.

Known in the art is to plug flashlights equipped with a power supply unit and battery into a 230 V A.C. receptacle by means of a plug provided on the flashlight itself in order to recharge the flashlight battery.

On the other hand, DE-197 12 636 A1 discloses a desktop charging station for mobile phones that can be connected to the power supply by a cable.

Mobile phones have become an integral part of our lives today, and are here to stay. They are enjoying ever-increasing popularity. The time between new model versions is getting shorter and shorter; the new mobile phones on the market incorporate more and more technical features and user capabilities. However, each mobile phone needs its own charger, which in turn can be plugged into a receptacle by means of a cable. Both the interface for docking the charging cable to the mobile phone and the shape and size of the charger plug itself vary depending on the manufacturer.

The current disadvantage to the user lies in the fact that he has to place his mobile phone right next to the receptacle during a charging process, depending on the length of the charger cable. Most overlong cables are cumbersome, and easily get tangled up. The mobile phone is set aside unprotected. There is a very high risk that the sensitive surfaces of the mobile phone will become damaged, or that the mobile phone will fall down. If several mobile phones varying by model or manufacturer are additionally on hand, there is a risk of mixing up the chargers, since they are most often not compatible with each other.

However, even other small electrical appliances that work at low voltages and have a storage unit for electrical energy (batteries, rechargeable cells or secondary cells) must be recharged at regular intervals. These devices include entertainment electronics, like portable voice and music file players, MP3 players, cassette, CD and DVD players, gaming consoles, Dictaphones, power tools, such as power drills and screwdrivers, household appliances, such as battery-operated mixers or whisks, but also electric shavers and electric toothbrushes and water picks, meaning all possible devices with a power on the order of 100 W or less; the direct voltage at which these devices operate ranges from 2 to 24 V.

All of these devices are equipped with a rechargeable cell that can be connected to an A.C. power source; a direct voltage is then generated via a power supply unit as the output voltage, e.g., having a value of 3.0 V, 4.5 V, 6.0 V, 9.0 V, etc. However, some of the devices listed above are suitable for accommodation on a primary winding of the alternating voltage network to inductively excite a secondary winding contained in the small appliance itself. The secondary alternating voltage generated in the secondary winding is then rectified by means of a rectifier with a diode or thyristor, by means of a bridge rectifier (Graetz circuit), making it possible to charge a battery contained in the small appliance.

However, most of the other devices listed above are only equipped with a battery, so that the power supply unit of the charging station must contain both a transformer and a rectifier.

The object of the invention is to provide a charging station that can be used to charge a variety of small electrical appliances.

In addition to being suitable for any low-voltage devices with a power measuring up to 100 W, i.e., with a voltage ranging from 2 to 24 V, the charging station according to the invention is especially suitable as a cableless charging station for mobile phones.

For example, the invention offers the ability to use a molded clamping device to stand the mobile phone up and dock it to the specially designed interface, which provides added support, mount it there and plug the entire unit into a serial receptacle with the plug on the rear side, leaving it there during the charging process and beyond. No cables get in the way. The charging process is always in the field of vision, e.g., as the result of the integrated charger lamp in the form of an LED on the front side. As a result, for example, the invention provides protection for the sensitive mobile phone technology.

The sensitive casing for the mobile phone is protected against scratches and unintended damage. Given the right dimensions for the charging station, it also becomes possible to charge two or more mobile phones or several other small appliances simultaneously. Further, the charging station can exhibit dimensions, e.g., a height of 175 mm, a width of 90 mm and a depth of 57 mm (without plug), that make it possible to plug several chargers into the wall receptacles one next to the other, in particular with the wall receptacles arranged horizontally next to each other. In this way, for example, each charging station can remain permanently in a wall receptacle. The chargers and excessively long cables included with a mobile phone or another small appliance are unnecessary.

The use of the invention yields several advantages: The mobile phone is protected during a charging process, and visible from the front during a charging process. A charging cable is no longer required. The mobile phone is secured and protected against dropping during the charging process; the charging station is also suited for holding the mobile phone for an extended period of time, during which the user does not carry it with him.

The subclaims, specification and drawings exhibit advantageous further developments of the invention.

It is particularly advantageous to equip the charger with a plurality of adapters secured to at least one carrier for the sockets of various small appliances. This holds true in particular for the sockets in mobile phones of different manufacturers, so that, for example, when only six different adapters are on hand, far more than 90% of all types of mobile phones that are popular and available on the market can be charged with the universal charger according to the invention.

To permit easy switching between the various adapters of the charger, the at least one carrier inside the charger is slidably and/or rotatably mounted on a shaft.

For reasons of structural design, the shaft can preferably be inserted into the charger so as to be essentially flush with the plugging direction of the receptacle; the shaft can also be aligned at a right angle to the plugging direction, or in another direction. The shaft can advantageously be fixed, in particular latched, securely in each position of an adapter.

The charger is preferably designed in such a way that a mechanical or motorized switch can be actuated to move the desired adapter for a low-voltage appliance to be charged into a position in which it can be secured in the fixture, brought into electrical contact with the matching adapter, and charged.

The switch or mechanism is preferably rotatable or tiltable in design. If the switch is a pressure switch, the shaft that holds the adapters can be moved from one rotational setting to the next during each actuation based on the principle of a ball-point pen, until the desired adapter is in the position in which a low-voltage appliance, in particular a mobile phone, can be fitted onto the adapter.

In another advantageous embodiment, the name of the small appliance belonging to the adapter and/or manufacturer of the small appliance and/or a designation selected by the user can be displayed on a front display panel. This measure also further enhances the level of comfort afforded by the charging station.

In one advantageous embodiment of the invention, the switch, display, adapter position and/or another element of the charger is fitted with a lamp, in particular with a light-emitting diode. In particular, a logo or special design applied to the charger can also be backlit. This invention also involves backlighting the casing at any specific locations or as a whole.

From a structural standpoint, the charger can be designed in such a way as to encompass a basic body that holds the power supply unit, and mounts for holding the small appliance in the charging position. The mounts preferably consist of a front mount and side mounts, so as to encompass all sides of the small appliance to be charged.

To provide an outer jacket of the charger tailored to the specific dimensions of the small appliance to be charged, at least one of the mounts can be shifted, rotated and/or spring-loaded relative to the basic body. As a result, the charger assumes the shape most suited for optimally holding the device to be charged and protecting it against dropping, either automatically already or through proper adjustment by the user.

To this end, the lateral mounts are designed as resilient projections for holding the small appliance from above. In a special embodiment, the lateral mounts of the charger are mounted so that they can rotate, especially around a perpendicular axis, and be twisted out of their resting position against the restorative force of a tension spring, thereby securely holding the small appliance to be charged between them.

The charger is preferably equipped with a visual and/or audio display means to show the charge state of the small appliance. As a result, the user can already tell a distance away whether the small appliance has already been completely charged, or how long it will still take for the small appliance to reach the desired charge state.

In another preferred embodiment of the invention, the shaft carrying the adapter is provided with several sliding contacts to establish an electrically conductive connection between the ground output and another output of the power supply unit with a specific voltage, and a ground contact of the adapter as well as another contact of the adapter to which the voltage is applied, just as to the other output of the power supply unit.

It can also be provided that the charger exhibit an area for holding an image, in particular behind a protective pane, especially one made out of plexiglass. The rear wall of the charging station in terms of the invention can be shaped by a changing frame with image area. In addition, this makes it possible to change out images and graphics, allowing each user to individually recognize his mobile phone charging station without searching and tedious comparison.

In another embodiment, the charger exhibits a lamp that can be activated in particular via a photoelectric lighting controller, in particular for the image area. The latter can be regulated via a photocell with photoelectric lighting controller, so that the charger simultaneously serves as an orientation light in the dark.

The charger has an integrated lamp, e.g., which can be controlled via a photocell with lighting controller. Hence, the invention simultaneously provides an orientation light in the dark.

Several embodiments are possible in terms of the invention, e.g., for incorporating and developing an interface as a hands-free device (Blue Tooth function) for the mobile phone.

The rear plug unit is preferably height-adjustable, so as to counter any potential obstacles, e.g., a light switch situated over the receptacle.

In one embodiment of the invention, the rear plug unit secured to the rear of the charger can be rotated, e.g., so as to counter the obstacle presented by a receptacle built in with perpendicularly incorporated plug openings.

The rear plug unit is either designed with a plug according to European standards, or configured based on country-specific plugs.

In another possible application, the device according to the invention has mounts for miniature loudspeakers, and/or miniature loudspeakers can be integrated into the casing. This makes it possible to connect MP3-capable mobile phones that have been placed in the charging station with the loudspeakers and enjoy the spatial acoustics of the stored MP3 content.

All illustrated embodiments .are based on the underlying idea of the invention to provide a cableless charging station for low-voltage appliances, in particular mobile phones, thereby eliminating the disadvantages associated with handling as practiced previously.

The device according to the invention will be explained in greater detail below based on illustrated embodiments, making reference to the attached drawings. Shown on:

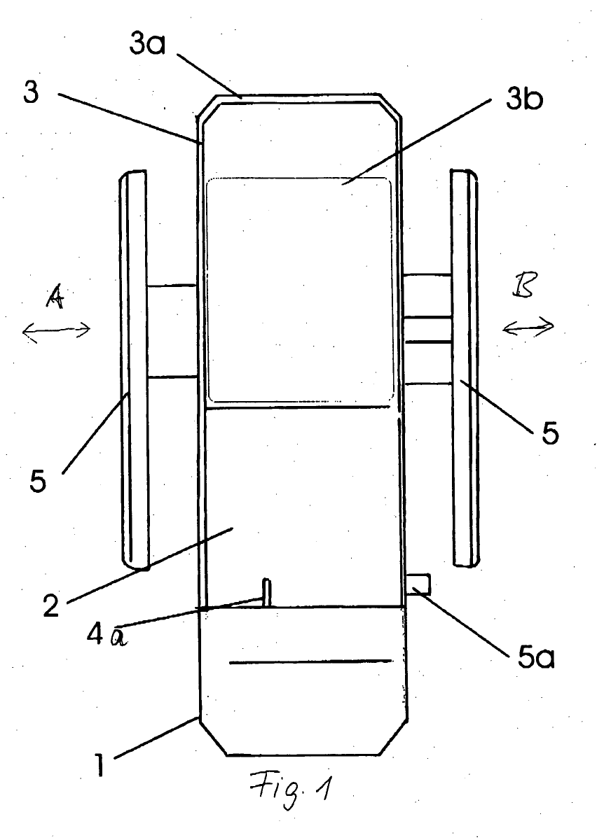

FIG. 1 is a front view of a first embodiment of a charger, into which is placed a mobile phone to be charged;

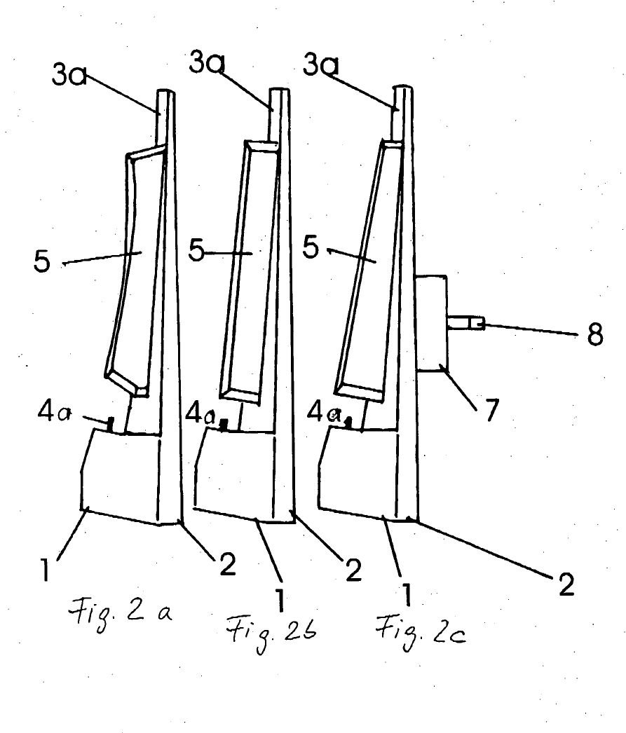

FIGS. 2a, b, c are side views of embodiments of the charger according to FIG. 1, wherein various lateral clamping devices are used;

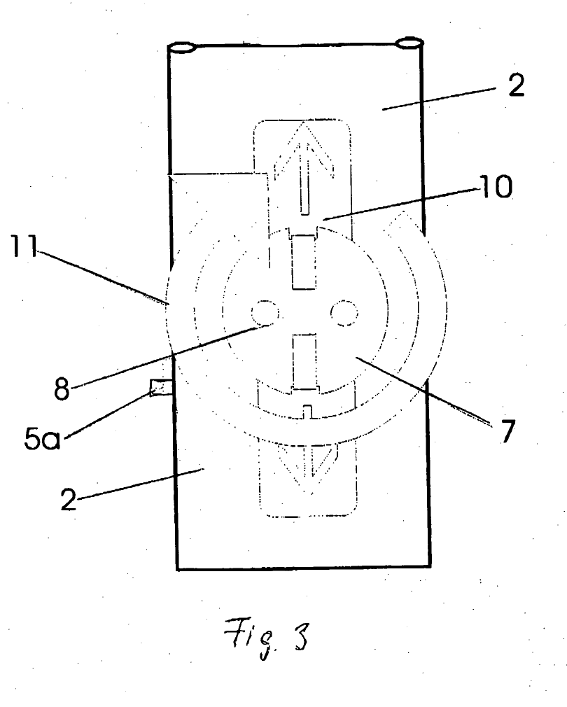

FIG. 3 is a rear view of the charger according to FIG. 1;

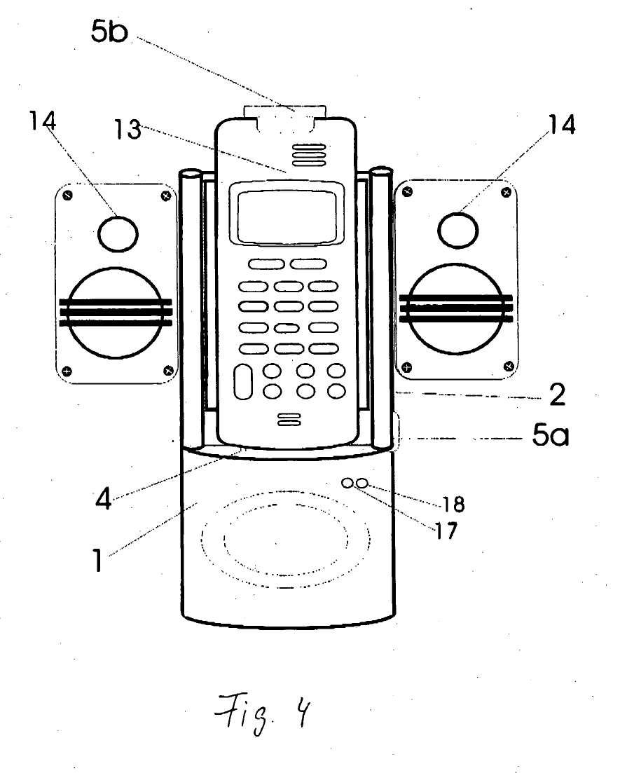

FIG. 4 is the charger according to FIG. 1, wherein a mobile phone has been placed in the charger, and miniature loudspeakers have been introduced on the side;

FIG. 5a is the charger according to FIG. 1 with a mobile phone fixed between the clamping devices;

FIG. 5b are plates or arrangements with adapters as the direct voltage outputs for connection with a terminal socket for various models of mobile phones or other small appliances that can be placed in the charger;

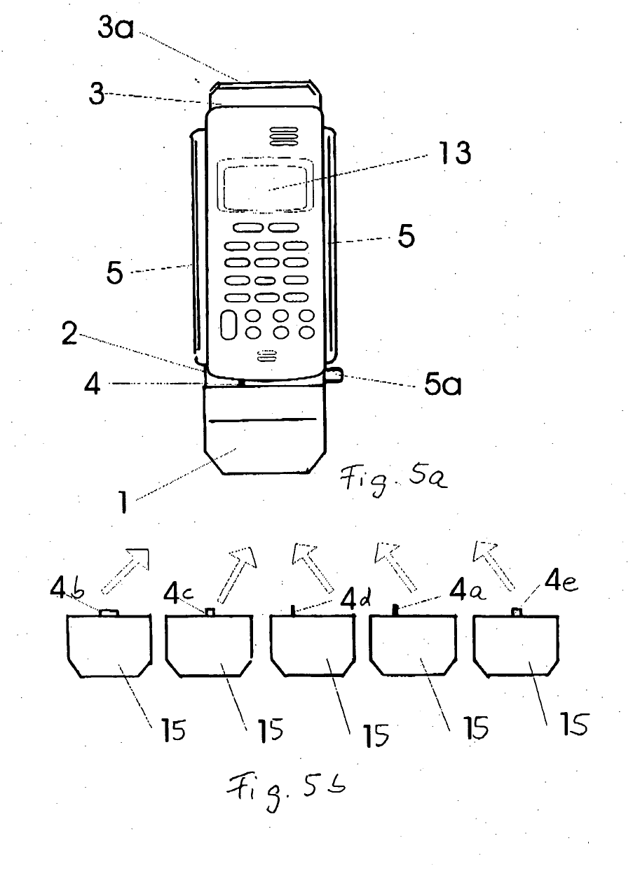

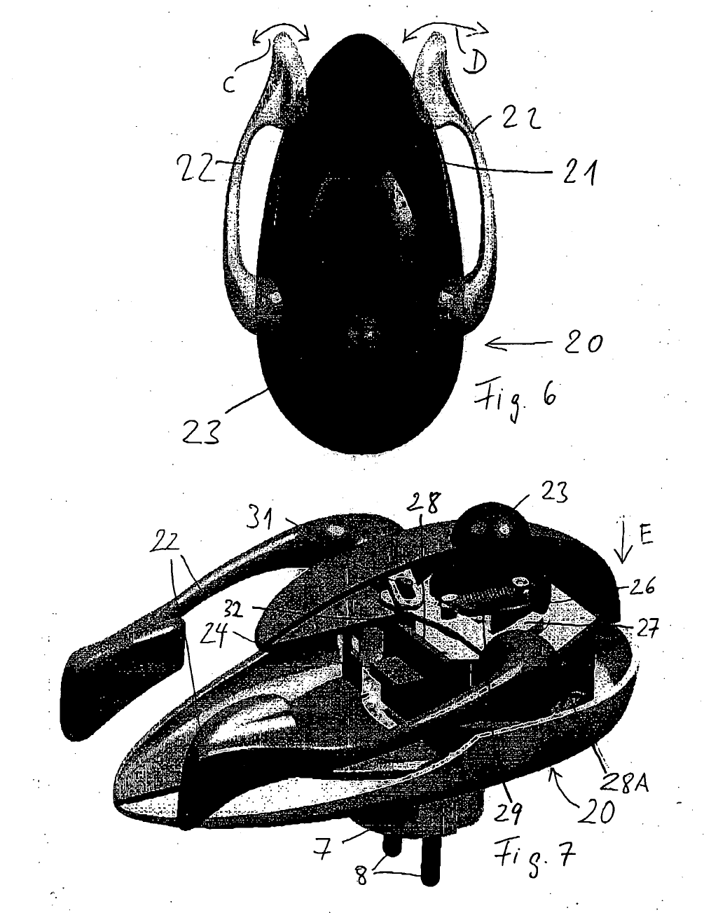

FIG. 6 is a top view of another embodiment of the charging station;

FIG. 7 is a perspective view of the charging station according to FIG. 6, partially open;

FIG. 8 is a top view of the partially open charging station according to FIG. 6;

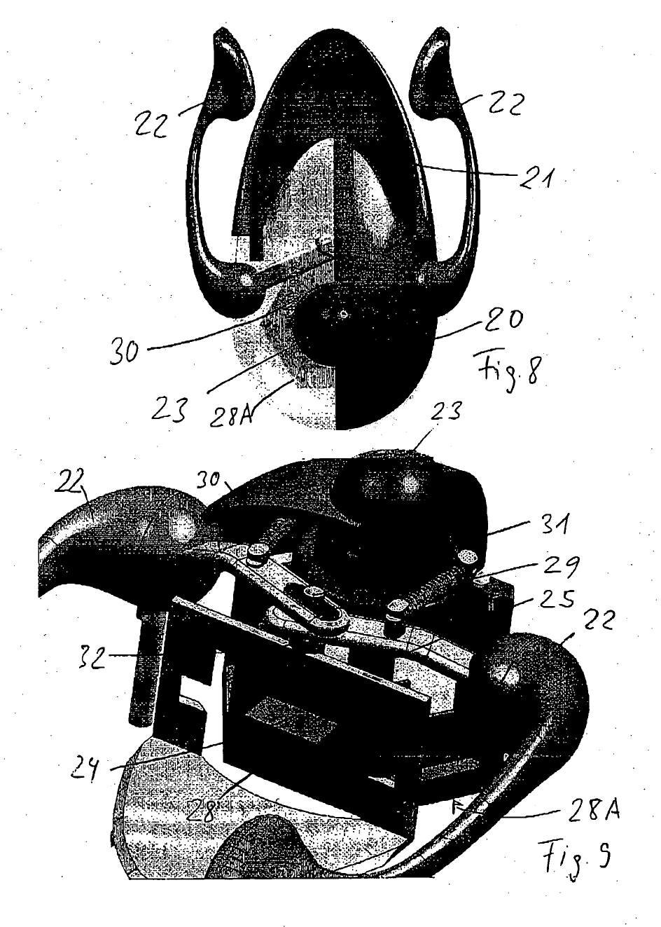

FIG. 9 is a perspective view of the mount for the clamping devices of the charging station, magnified, in conjunction with a front knob;

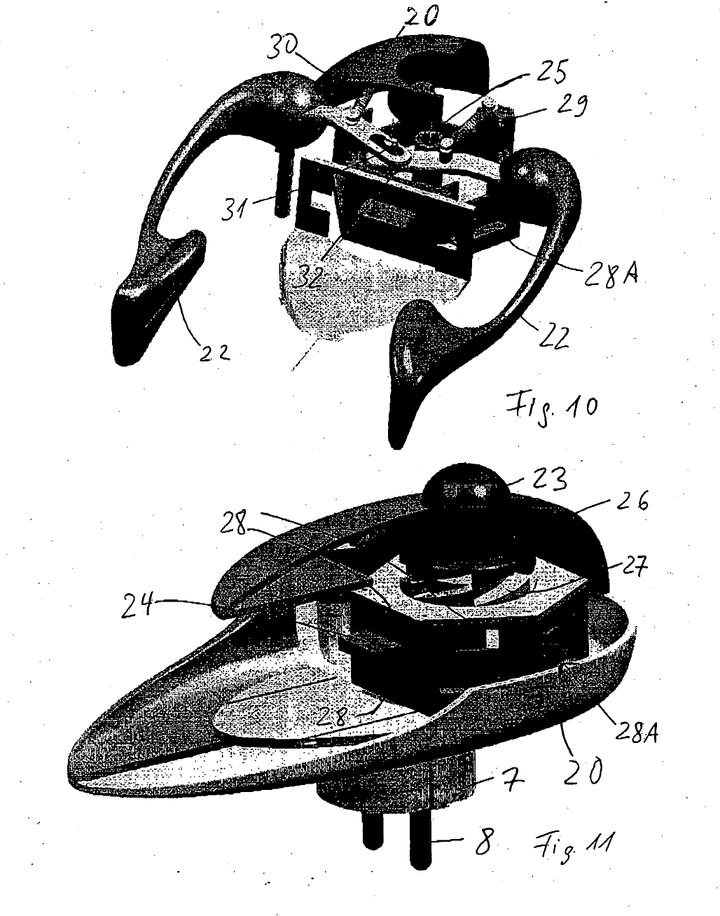

FIG. 10 is a perspective view of the clamping devices according to FIG. 9 without the knob;

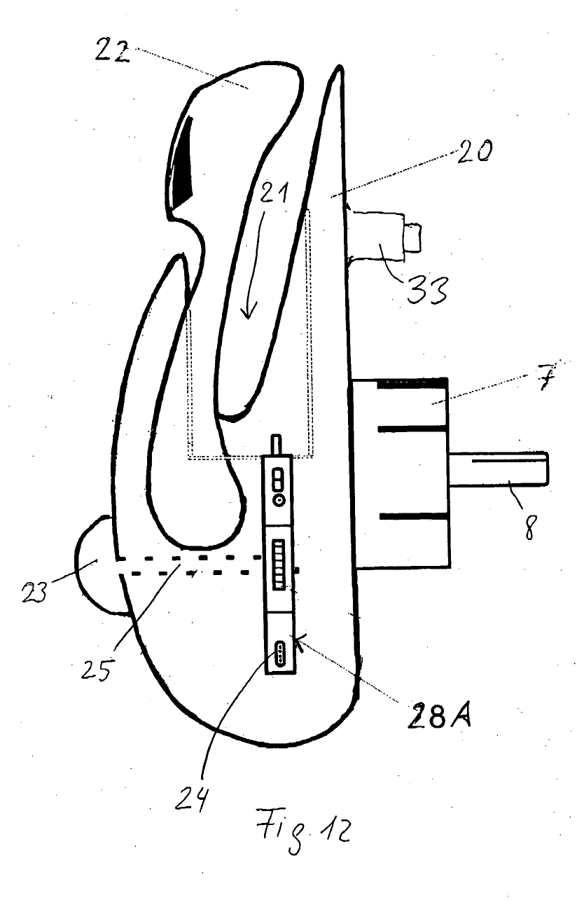

FIG. 11 is a perspective view of the knob and adjusting shaft, on which the knob is situated; and

FIG. 12 is a side view of the charging station according to FIG. 6, partially cut.

A first charger (FIG. 1) comprises a casing 1 with integrated charging electronics, i.e., in particular with a power supply unit encompassing a transformer and rectifier for generating at least one output direct voltage at an output terminal. The charger consists of a rear wall 2 with an area for holding an image. An image frame 3a, e.g., made of acrylic glass, comprises an image area 3b for holding an exchangeable image. One adapter 4a out of a plurality of available adapters 4a, 4b, 4c, 4d and 4e (FIG. 5b) is used for connection to a mobile phone 13 (FIG. 5a) or another low-voltage appliance to be charged.

The charger has lateral mounts or clamping devices 5 that can be adjusted in the direction of arrows A and B, and latched in various positions, which are manually fixed in freely selectable positions by manually exerting a lateral pressure to clamp and mount a mobile phone 13 to be charged. The clamping devices 5 can be released from their positions again by actuating a knob 5a.

FIGS. 2a, b and c show several chargers with-varyingly designed clamping devices 5b, 5c, 5d as alternatives. In addition, the modular construction of the rear wall 2 is visibly depicted. The plug 7 secured to the rear side is shown only in the alternative depicted on FIG. 2c, complete with accompanying plug pins 8. The image frame 3a is inserted on the rear wall. The clamping devices 5b, 5c, 5d and the casing 1 or the casing module are also visible from the side, as is the mobile phone charging terminal 4a. The modular design makes it possible to secure a country-specific plug 7 on the rear side of the rear wall 2.

The plug 7 can be adjusted in a perpendicular direction (FIG. 3). In addition, the plug 7 can be made to rotate continuously with a rotating device 11.

In another embodiment (FIG. 4) of the invention, loudspeakers 14 are integrated into the clamping devices 5 or secured laterally thereto. This enables an acoustic transmission of files stored in a docked mobile phone 13, e.g., MP3 files. The charger shown on FIG. 4 is additionally equipped with an optical display 18 to visualize the charge status of the mobile phone 13 to be charged, as well with a photocell 17. If the latter detects that a room is dark or poorly lit, the charger lamp is activated (not shown here).

FIG. 5a shows the charger depicted on FIG. 1 holding a mobile phone 13, wherein the adapter 4 is plugged into its power socket. Other models of mobile phones or other low-voltage devices are provided with other adapters 4b, 4c, 4d and 4e (FIG. 5b), which are arranged either on replaceable plates 15 or other arrangements that can be connected with the casing 1, or on a sliding strip situated in the charger.

In another embodiment (FIG. 6-12), a charging station exhibits a casing 20, which consists of a fixture or compartment 21 for holding a mobile phone or another low-voltage appliance. The latter is held between two clamping devices 22 that can be elastically pivoted in the direction of arrows C, D. The front of the charger has a pressure-actuated knob 23 for selecting and setting the position of an adapter 24 (FIG. 7) from a plurality of adapters 24 arranged on an adjustment shaft 25 (FIG. 9). The knob 23 can be pushed by pressing in the direction of an arrow E; it is returned to its initial position by a spring. During each actuation of the knob 23, latching projections 26 designed as steep planes interact with corresponding steep planes 27 on the shaft 25, thereby causing the shaft 25 to rotate. The shaft 25 carries an adapter carrier 28A equipped with a plate 28 that bears a respective adapter 24; as the shaft 25 rotates, so too does the adapter carrier 28A, bringing the respectively fitting adapter 24 into a position accessible from outside for accommodating the small appliance to be charged, e.g., in the charging position. Therefore, when six different plates 28 are present as depicted on FIG. 7, each carrying an adapter 24 (only a single adapter 24 is shown for purposes-of simplification) and together forming part of the adapter carrier 28A situated on the shaft 25, so too are a corresponding six pairs of steep planes 26, 27, in order to further turn the shaft 25, and hence the adapter carrier 28A, around a respective angle of 60°. The knob 23 and shaft 25 here operate based on the ballpoint pen principle. The same applies if a larger number of adapters are to be provided. In this case, the shaft 25 can also accommodate several arrangements of plates each carrying an adapter, which can be moved in the direction of the longitudinal axis of the shaft in order to be positioned where a socket of a device to be charged can be slid onto the adapter.

The clamping devices 22 are either made out of a sufficiently elastic material to flexibly hold a device to be charged between them, or a mechanism is provided for adjusting the clamping devices 22 against the force of tensile springs 29, 30. To this end, the clamping devices 22 are each pivoted on a shaft 31 or on a hollow shaft 32 enveloping the shaft 31.

Otherwise, the charger shown on FIG. 6 to 12 is equipped with the same components as the charger on FIG. 1 to 5b. Therefore, the invention provides a cableless charging station, which is suitable in particular for mobile phones of all designs and models, and can be permanently plugged into serial receptacles for retaining and charging the battery of a mobile phone.

As an alternative to actuation via the knob 23 on the front of the charging station, the shaft 25 is adjusted using a knurled screw accessible on the side of the charging station in another embodiment.

In addition, the charging station can have a plug for connection 33 to a cigarette lighter in a motor vehicle alternatively or additionally to the plug 7. Since the latter already provides a direct voltage signal, it can be relayed directly to the sliding contacts of the adjustment shaft 25 and the adapter adjusting wheel 28A without having to be transformed to a lower voltage and rectified in a power supply unit like the mains voltage received via the plug 7.

1. An electrical charger equipped with a plug (7) for cableless insertion into a wall receptacle, with a power supply unit and a fixture for holding an electrical low-voltage appliance (13) that is to be charged and has a storage unit for electrical energy, characterized in that the charger is equipped with at least one adapter (4a-4e; 24) for a power socket of the low-voltage appliance and/or with a mount containing a primary winding for the induction of a secondary winding in the low-voltage appliance that can be accommodated on the mount.

2. The charger according to claim 1, characterized in that it is equipped with a plurality of adapters (4a-4e; 24) secured to at least one carrier, in particular on a respective carrier plate (15, 28) for the sockets of various small appliances.

3. The charger according to claim 1, characterized in that the at least one carrier inside the charger is slidably and/or rotatably mounted on a shaft (25).

4. The charger according to claim 3, characterized in that the shaft (25) is essentially flush with the plugging direction of the receptacle in which the charger can be plugged.

5. The charger according to claim 3, characterized in that the shaft (25) can be fixed, in particular latched, securely in each position in which an adapter (24) can be connected with a low-voltage appliance (13) to be charged.

6. The charger according to claim 3, characterized in that a switch (23) can be actuated to bring an adapter (24) for a socket of a low-voltage appliance to be charged into a position in which the latter can be secured in the fixture, brought into electrical contact with the matching adapter (24), and charged.

7. The charger according to claim 6, characterized in that the switch is a rotary switch, a drive motor-actuated switch or a sensor-equipped switch.

8. The charger according to claim 6, characterized in that the switch is a pressure switch (23), with which the shaft (25) and an adapter carrier (28A) accommodated thereupon can be moved further from one rotational setting to the next during each actuation based on the principle of a ball-point pen.

9. The charger according to claim 1, characterized in that the name of the low-voltage appliance (13) belonging to the adapter (24) and/or the manufacturer of the low-voltage appliance (13) and/or a designation to be specified by the user can be shown on a front display panel.

10. The charger according to claim 6, characterized in that the switch (23), display, position of the adapter and/or another element of the charger is equipped with a lamp.

11. The charger according to claim 1, characterized in that it encompasses a basic body or a casing (1, 20) that holds the power supply unit, and mounts (5, 22) for holding the low-voltage appliance in the charging position.

12. The charger according to claim 11, characterized in that the mounts consist of a front mount and side mounts (5, 22).

13. The charger according to claim 11, characterized in that at least one of the mounts (5, 22) can be shifted and/or spring-loaded relative to the basic body (1, 20).

14. The charger according to claim 13, characterized in that the lateral mounts are designed as resilient projections for holding the small appliance from above.

15. The charger according to claim 14, characterized in that the lateral mounts (5, 22) of the charger are mounted so that they can rotate, and be twisted out of their resting position against the restorative force of a tension spring (29, 30).

16. The charger according to claim 1, characterized in that it is equipped with an optical and/or acoustic display means (18) for displaying the charge state of the small appliance.

17. The charger according to claim 3, characterized in that the shaft (25) and/or adapter carrier (28A) with several sliding contacts for establishing an electrically conductive connection between the ground output and another output of the power supply unit with a specific voltage, and a ground contact of the adapter (4a-4e; 24) as well as another contact of the adapter (4a-4e; 24) to which the voltage is applied, just as to the other output of the power supply unit.

18. The charger according to claim 1, characterized in that exhibits an area for holding an image, in particular behind a protective pane, especially one made out of plexiglass or acrylic glass.

19. The charger according to claim 1, characterized in that it exhibits a lamp that can be activated in particular via a photoelectric lighting controller (17).

20. The charger according to claim 1, characterized in that it can have a plug for connection (33) to a cigarette lighter in a motor vehicle alternatively or additionally to the plug (7).
